(19) United States
(12) Patent Application Publication
(10) Pub. No.: US 2011/0057849 A1
(43) Pub. Date: Mar. 10, 2011

(54) DYNAMIC POLARIZATION ADJUSTMENT FOR A GROUND STATION ANTENNA

(75) Inventors: Guy NAYM, Netanya (IL); Hanan KEREN, Kfar Sava (IL)

(73) Assignee: ORBIT COMMUNICATION LTD., Netanya (IL)

(21) Appl. No.: 12/555,007

(22) Filed: Sep. 8, 2009

(51) Int. Cl. H01Q 19/00; H01Q 3/00; H01Q 13/00; H01Q 9/16

(52) U.S. Cl. 343/756; 343/762; 343/786; 343/793

(57) ABSTRACT

A ground station antenna includes a LNB with at least one dipole, a feed horn, a waveguide between the LNB and the feed horn, and a rotation mechanism. By rotating a portion of the waveguide, the polarization of an electromagnetic wave propagating between the LNB and a satellite is transformed to match the polarization to (one of) the dipole(s) and to an antenna on the satellite. Another ground station antenna includes a main waveguide, two mutually orthogonal branch waveguides, a coupling mechanism for coupling two orthogonal antenna dipoles to the proximal end of the waveguide, and a transformation mechanism that transforms the polarization of an electromagnetic wave propagating between the branch waveguides and a satellite via the antenna dipoles to match the polarization to one of the branch waveguides and to an antenna on the satellite.

### FIELD AND BACKGROUND OF THE INVENTION

The present invention relates to a ground station antenna for exchanging electromagnetic signals with a satellite and, more particularly, to a ground station antenna, for a mobile platform, with improved dynamic polarization alignment with the satellite's transponder.

FIGS. 1A and 1B shows a typical parabolic dish antenna 10 for communicating with a communication satellite such as a Fixed Service Satellite (FSS). Antenna 10 includes a parabolic dish 12 and a Low Noise Block downconverter Feed horn (LNBF) 14 supported by supports 16 at the focus of dish 12. Dish 12 is mounted on a mount 18. FIG. 1A is a perspective view of antenna 10. FIG. 1B is a frontal view of dish 12 and LNBF 14. LNBF 14 includes a Low Noise Block (LNB) with two orthogonal receive dipoles 20 shown in FIG. 1B in phantom. Each dipole receives Kᵤ-band signals from the FSS at which antenna 10 is aimed.

An FSS is a geostationary satellite whose transponders transmit and receive linearly polarized radio waves in the Kᵤ band. One transponder of a transponder pair transmits and receives horizontally polarized waves. The other transponder of the transponder pair transmits and receives vertically polarized waves. LNB dipoles 20 are intended for receiving signals in respective allocated frequency segments from respective transceivers of the FSS: the horizontal dipole antenna 20 is for receiving signals from the transponder that transmits horizontally polarized waves and the vertical dipole antenna 20 is for receiving signals from the transponder that transmits vertically polarized waves. If the FSS is at the same longitude as a stationary antenna 10, then when dish 12 is aimed at the FSS by appropriate adjustment of mount 18 in azimuth and elevation, the horizontal LNB dipole 20 is aligned with the horizontal polarization direction of the FSS and the vertical LNB dipole 20 is aligned with the vertical polarization of the FSS. If the FSS is not at the same longitude as a stationary antenna 10 then the polarization directions of the FSS are tilted with respect to LNB dipoles 20 and dish 12 must be rotated, as indicated by an arrow 22 in FIG. 1B, to align LNB dipoles 20 with the polarization directions of the FSS.

If antenna 10 is stationary, then dish 12 only needs to be rotated once and then fixed in place on mount 18. If antenna 10 is mounted on a moving platform such as a truck, a boat, an aircraft or some other vehicle, the orientation of dish 12 must be adjusted continuously to keep dish 12 pointed at the FSS and to keep LNB dipoles 20 aligned with the polarization directions of the FSS. Even if antenna 10 is stationary, if antenna 10 communicates with a satellite that is not in a geosynchronous obit, dish 12 must be adjusted continuously to keep dish 12 pointed at the satellite and to keep LNB dipoles 20 aligned with the satellite's polarization directions. Hsiung, in U.S. Pat. No. 6,377,211, teaches an antenna aiming apparatus for keeping an antenna that is mounted on a moving vehicle properly aligned with a satellite in a non-geosynchronous orbit. U.S. Pat. No. 6,377,211 is incorporated by reference for all purposes as if fully set forth herein.

Heretofore, dish 12 has been rotated as a whole, in the directions indicated by arrow 22, to keep LNB dipoles 20 aligned with the polarization directions of the satellite with which antenna 10 communicates. It would be highly advantageous to be able to keep LNB dipoles 20 aligned with the polarization directions of the satellite without having to rotate dish 12 as a whole.

### SUMMARY OF THE INVENTION

According to the present invention there is provided a ground station antenna including: (a) a low noise block having at least one dipole; (b) a feed horn; (c) waveguide, between the low-noise block and the feed horn, operative to transform a polarization of an electromagnetic wave propagating between the low-noise block and a communications satellite; and (d) a mechanism for rotating at least a portion of the waveguide, relative to the low-noise block, so as to match the polarization to a respective dipole of the low-noise block and also to a satellite antenna on the communication satellite.

According to the present invention there is provided a ground station antenna including: (a) a main waveguide; (b) two mutually orthogonal distal branch waveguides at a distal end of the main waveguide; (c) a coupling mechanism for coupling two orthogonal antenna dipoles to a proximal end of the main waveguide; and (d) a transformation mechanism operative to transform a polarization of an electromagnetic wave propagating between the distal branch waveguides and a communications satellite via the antenna dipoles so as to match the polarization to one of the distal branch waveguides and also to a satellite antenna on the communication satellite.

According to the present invention there is provided a method of rotating an input direction of polarization of a linearly polarized transverse wave to an output direction, including the steps of (a) transforming the transverse wave into a circularly polarized transverse wave; and (b) transforming the circularly polarized transverse wave into a linearly polarized transverse wave whose direction of polarization is the output direction.

One ground station antenna of the present invention includes a low noise block with one dipole or with two orthogonal dipoles, a feed horn and a waveguide. The waveguide is between the low-noise block and the feed horn. The waveguide is operative to transform the polarization of an electromagnetic wave that propagates between the low-noise block and a communication satellite. Examples of such transformations include rotating the plane of polarization of a linearly polarized wave, transforming a circularly polarized wave to a linearly polarized wave, and transforming a linearly polarized wave to a circularly polarized wave. The ground station antenna also includes a rotation mechanism for rotating at least a portion of the waveguide, relative to the low-noise block, so as to match the polarization of the electromagnetic wave to a respective dipole of the low-noise block and also to a satellite antenna on the communication satellite.

Preferably, the waveguide includes two polarizers. A “polarizer” is a phase shifter that receives a linearly polarized signal as input and converts it to a circularly polarized output signal, or vice versa. The rotation mechanism rotates a first one of the polarizers while a second one of the polarizers remains fixed relative to the dipole(s) of the low-noise blocks.

In one preferred embodiment of the ground station antenna, each polarizer includes a single respective dielectric slab. Most preferably, the dielectric slabs are quarter-wavelength slabs (relative to the wavelength of the electromagnetic wave). Also most preferably, the second dielectric slab is fixed at a 45-degree angle relative to the dipole(s) of the low-noise block.

In another preferred embodiment of the ground station antenna, the polarizers are quad ridge polarizers, most preferably quarter-wavelength (relative to the wavelength of the electromagnetic wave) quad ridge polarizers. Also most preferably, the second quad ridge polarizer is fixed at a 45-degree angle relative to the dipole(s) of the low-noise block.

Another ground station antenna of the present invention includes a main waveguide, two mutually orthogonal distal branch waveguides at a distal end of the main waveguide, a coupling mechanism for coupling two orthogonal antenna dipoles to a proximal end of the main waveguide, and a transformation mechanism. The transformation mechanism is operative to transform the polarization, of an electromagnetic wave, that propagates between the distal branch waveguides and a communication satellite via the antenna dipoles, so as to match the polarization of the electromagnetic wave to one of the distal branch waveguides and also to a satellite antenna on the communication satellite.

In one embodiment of the ground station antenna, the transformation mechanism includes two pairs of electrically-conducting dipoles mounted rotatably about the longitudinal axis of the main waveguide at the proximal end of the main waveguide, with both pairs of dipoles being oriented perpendicular to each other and to the longitudinal axis of the main waveguide. Preferably, the coupling mechanism couples each antenna dipole to one dipole of a respective dipole pair.

In another embodiment of the ground station antenna, the coupling mechanism includes two mutually orthogonal proximal branch waveguides at the proximal end of the main waveguide. Each proximal branch waveguide is coupled to a respective one of the antenna dipoles. The transformation mechanism includes two polarizers that are integral to the main waveguide (meaning that the polarizers are part of the main waveguide), with the first polarizer being rotatable relative to the branch waveguides wile the second polarizer remains fixed relative to the branch waveguides. Preferably, the second polarizer is fixed at a 45-degree angle (around the longitudinal axis of the main waveguide) relative to the distal branch waveguides. Also preferably, the polarizers are quad ridge polarizers, most preferably quarter-wavelength (relative to the wavelength of the electromagnetic wave) quad ridge polarizers.

A method of the present invention, for rotating the input direction of polarization of a linearly polarized transverse wave to an output direction, includes the step of transforming the transverse wave into a circularly polarized transverse wave and then transforming the circularly polarized transverse wave into a linearly polarized transverse wave whose direction of polarization is the desired output direction.

### BRIEF DESCRIPTION OF THE DRAWINGS

Various embodiments are herein described, by way of example only, with reference to the accompanying drawings, wherein:

FIGS. 1A and 1B show a prior art parabolic dish antenna;

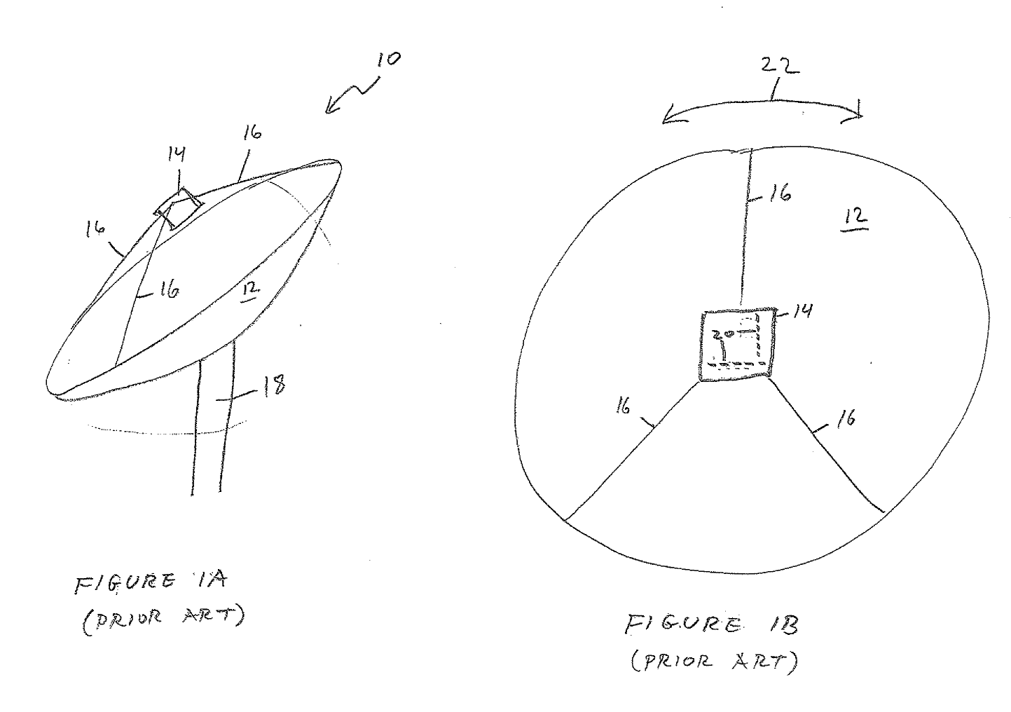

FIGS. 2A-2D illustrate a LNBF of the present invention;

FIG. 3 illustrates the tapering of the dielectric slab of the polarizer of FIG. 2C or 2D;

FIG. 4 is a simplified block diagram of a mechanism for pointing a moving ground station antenna at a geostationary satellite;

FIG. 5 is a transparent perspective view of a quad ridge polarizer;

FIG. 6 is a cross sectional view of the quad ridge polarizer of FIG. 5 along line 5-5 and perpendicular to the longitudinal axis;

FIG. 7 is a plot of XPD vs. frequency for the dual slab polarizer of FIG. 3 vs. the quad ridge polarizer of FIGS. 5 and 6.

FIGS. 8 and 9 illustrate embodiments of the present invention in which the mechanism for untangling the mixed linear polarization is downstream from fixed dipoles in reception and upstream from fixed dipoles in transmission.

### DESCRIPTION OF THE PREFERRED EMBODIMENTS

The principles and operation of a ground station antenna according to the present invention may be better understood with reference to the drawings and the accompanying description.

Although the present invention is described herein are in terms of a parabolic dish antenna such as antenna 10, the present invention is applicable to antennas of other shapes, e.g. flat antennas. Similarly, although the present invention is described herein in terms of radio-frequency signals in the Ku band, those skilled in the art will appreciate that the present invention also is applicable to other radio-frequency bands, such as the L band (1 GHz to 2 GHz), the S band (2 GHz to 3 GHz), the C band (4 GHz to 6 GHz), the X band (7 GHz to 9 GHz) and the Ka band (17 GHz to 20 GHz). Furthermore, although the present invention is described herein in terms of communication with a geostationary satellite, it will be appreciated that the present invention also is applicable to communication with satellites that are not in geosynchronous orbits.

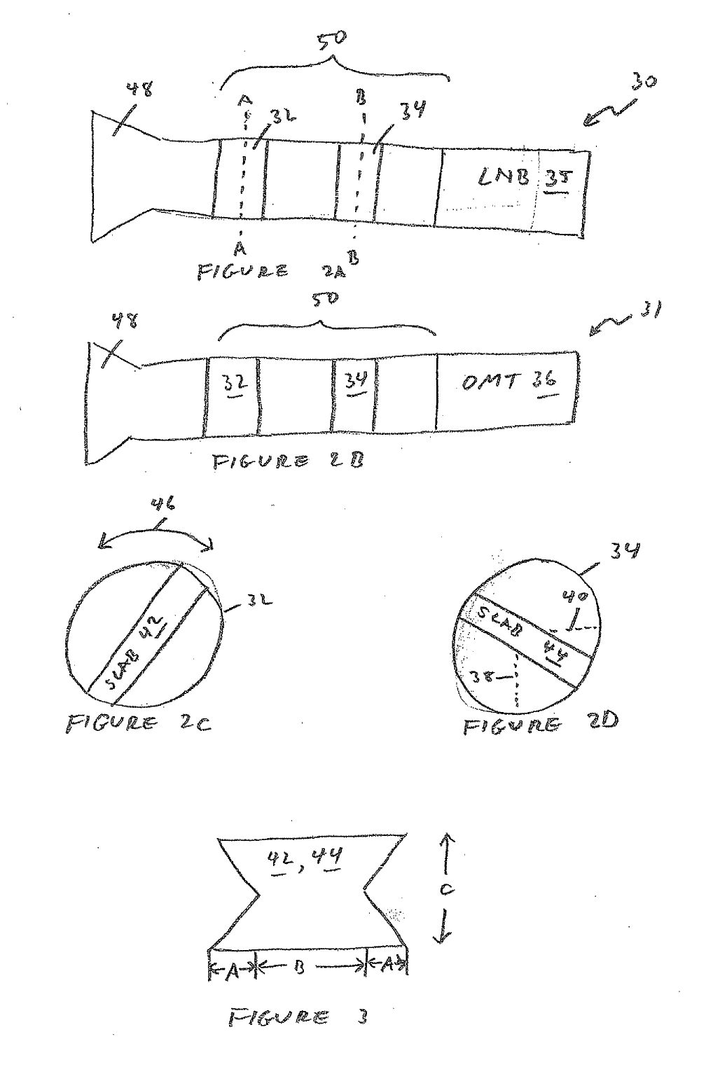

Returning now to the drawings, FIGS. 2A-2D illustrate two embodiments 30 and 31 of a LNBF of the present invention. FIG. 2A is a side view of LNBF 30 showing that LNBF 30 includes, in series, a feed horn 48, a waveguide 50 and a LNB 35. FIG. 2B is a side view of LNBF 31 showing that LNBF 31 includes, in series, feed horn 48, waveguide 50 and an Orthogonal Mode Transducer (OMT) 36. Waveguide 50 includes a rotating polarizer 32 and a fixed polarizer 34. FIG. 2C, a cross section of LNBF 30 through section A-A, shows that rotating polarizer 32 of LNBF 30 includes a quarter-wavelength dielectric slab 42. FIG. 2D, a cross section of LNBF 30 through section B-B, shows that fixed polarizer 34 of LNBF 30 includes a quarter-wavelength dielectric slab 44. Also shown in phantom in FIG. 2D are the orientations of the horizontal dipole 38 and the vertical dipole 40 of LNB 35. Slab 44 is fixed at a 45-degree angle to both horizontal dipole 38 and vertical dipole 40.

In general, a single quarter-wavelength dielectric slab that is placed at a 45-degree angle to a linearly polarized electromagnetic wave, transverse to the direction of propagation of the linearly polarized electromagnetic wave, transforms the linearly polarized electromagnetic wave to a circularly polarized electromagnetic wave. Appropriate rotation of just rotating polarizer 32, as indicated by an arrow 46 in FIG. 2C, suffices to keep LNB dipoles 38 and 40 aligned with the polarization directions of the satellite with which an antenna that includes LNBF 30 communicates. Specifically, rotating polarizer 32 is rotated to place slab 42 at a 45-degree angle to the polarization directions of the satellite. Rotating polarizer 32 transforms the linearly polarized signal from the satellite to a circularly polarized signal, and fixed polarizer 34 transforms the circularly polarized signal to a linearly polarized signal that is aligned correctly with the appropriate LNB dipole 38 or 40.

Without loss of generality, an incoming, linearly polarized electromagnetic signal may be represented as:

H_{IN}(ωt)=x cos(ωt)+y cos(ωt)

where x and y are unit vectors perpendicular and parallel to a quarter-wavelength dielectric slab and ω is the angular frequency of the signal. The quarter-wavelength slab delays the phase angle of the parallel component of the signal by 90 degrees but does not shift the perpendicular component of the signal. As a result, the outgoing signal on the other side of the quarter-wavelength slab is:

H_{OUT}(ωt)=x cos(ωt)+y sin(ωt)

which is a pure circularly polarized signal. At a frequency ±Δf with respect to the central frequency f₀ of the signal, a phase shift error

Δφ=(±Δf/f₀)(π/2)

is introduced that causes cross-polarization as follows:

$$\begin{matrix}{\underline{H}}_{OUT} ( ω t ) = \underline{x} cos ( ω t ) + \underline{y} sin ( ω t + Δϕ ) \\ = [ \underline{x} cos ( ω t ) + \underline{y} sin ( ω t ) ] + \underline{y} [ sin ( ω t + Δϕ ) - sin ( ω t ) ] \\ = [ \underline{x} cos ( ω t ) + \underline{y} sin ( ω t ) ] + \underline{y} [ 2 cos ( ω t ) sin ( Δϕ / 2 ) ]\end{matrix}$$

The first term in brackets on the right hand side represents the right hand circularly polarized wave. The second term in brackets on the right hand side represents the linear unbalanced wave, which is half right hand circularly polarized and half left hand circularly polarized. Taking the time averaged power of these terms gives, for the first (circular) term:

$$〈 {[ \underline{x} cos ( ω t ) + \underline{y} sin ( ω t ) ]}^{2} 〉 = 〈 {[ \underline{x} cos ( ω t ) ]}^{2} + 2 〈 {[ \underline{xy} sin ( ω t ) cos ( ω t ) ]}^{2} 〉 + 〈 {[ \underline{y} sin ( ω t ) ]}^{2} 〉 = 0.5 + 0.5 = 1$$

and for the second (linear) term at 50% power:

<[y√2 cos(ωt)sin(Δφ/2)]²>=[sin(Δφ/2)]²

Therefore, the cross polarization for a single slab in units of dB is

XPD=20 log [sin(Δφ/2)]

and the cross polarization for both slabs 42 and 44 is

XPD=20 log [sin(Δφ/2)]+3 dB

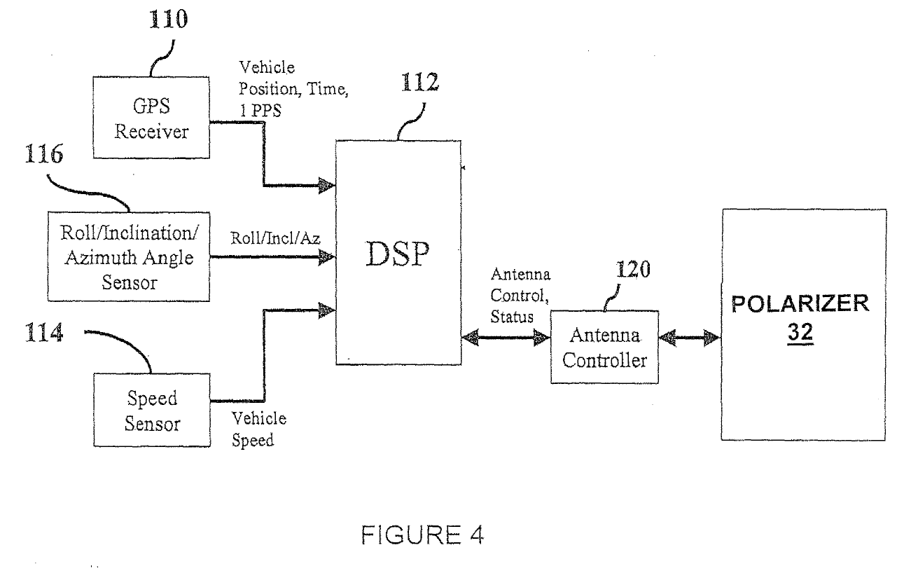

To minimize reflections in waveguide 50, slabs 42 and 44 should be tapered in the direction of propagation, as shown in FIG. 3. The lengths A and B should satisfy 2A+B≈0.25λ/√∈, where λ is the wavelength of the electromagnetic signal in free space and ∈ is the dielectric constant of the dielectric material of slabs 42 and 44. Length C is tuned for optimal matching of the propagating wave through waveguide 50. Typical values of A, B and C for a Ku-band LNBF 30 are 2 mm, 4 mm and 4 mm, respectively. The dielectric material of slabs 42 and 44 should be of low loss tangent at the operating frequency, e.g. Plexiglas™ (polymethyl methacrylate).

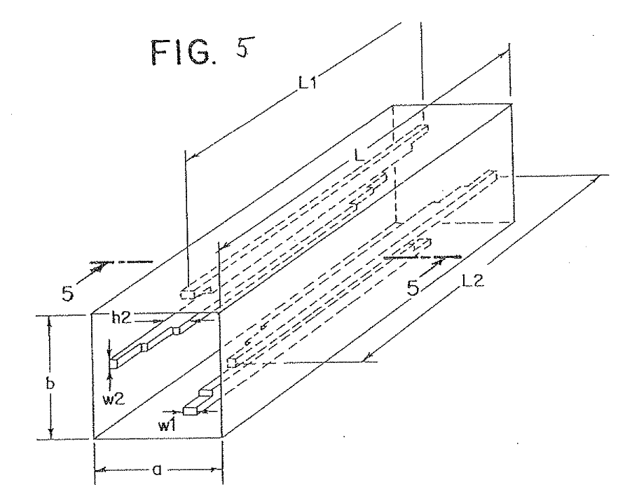

FIG. 4, which is adapted from FIG. 2 of Hsiung, is a simplified block diagram of a mechanism for pointing a parabolic dish antenna, that includes LNBF 30 and that is mounted on a moving vehicle, at a geostationary earth satellite while rotating polarizer 32 to keep LNB dipoles 38 and 40 aligned with the polarization directions of the satellite. A Global Positioning System (GPS) receiver 110 mounted on the vehicle receives signals from GPS satellites in a known manner and produces signals that represent vehicle position, the current time (coordinated Universal Time or UPC) and a one-pulse-per-second timing pulse, all of which are applied to a Digital Signal Processor (DSP) 112. The vehicle position information includes latitude, longitude and altitude. A vehicle speed sensor 114 produces signals representing the speed of the vehicle, which are applied to DSP 112. DSP 112 also receives signals representing vehicles roll, inclination (pitch) and azimuth angle (yaw) from (an) appropriate sensor(s) 116 mounted on the vehicle. One such sensor is the Crossbow Model HDX-AHRS, available from Crossbow Technology, Inc. of San Jose Calif., that senses roll, inclination and azimuth angle, and that includes a three-axis magnetometer to make a true measurement of magnetic heading. The azimuth information may be in the form of signals representing vehicle yaw relative to magnetic north; magnetic correction then can be performed in DSP 112 based on the location information from GPS receiver 110 together with stored magnetic declination data. GPS receiver 110, orientation sensor(s) 116 and speed sensor 114 provide DSP 112 with data at an update rate faster than once per second, thereby allowing the antenna pointing system to have a near-real-time response.

The location of the satellite also is stored in DSP 112. DSP 112 processes the sensor signals relative to the location of the satellite to produce antenna drive or control signals, which are applied to the drive motors of the parabolic dish antenna, including a motor for rotating polarizer 32, to keep LNBF 30 pointed at the satellite and to rotate polarizer 32 to keep LNB dipoles 38 and 40 aligned with the polarization directions of the satellite.

If the communication satellite with which LNBF 30 communicates is a satellite, such as a Direct Broadcast Satellite (DBS), that use circularly polarized signals, then slab 42 is kept fixed at a 90-degree angle to slab 44. The input signal may be represented as:

H_{IN}(ωt)=x cos(ωt)=y sin(ωt)

A quarter-wavelength slab placed parallel to the x direction converts the circularly polarized signal to a linearly polarized signal with the vector components

H_{OUT}(ωt)=x cos(ωt)±y cos(ωt)=(x±y)cos(ωt)

i.e., with a linear polarization direction at a 45-degree angle to the slab. Accordingly, if slab 42 is aligned 45-degrees or 135-degrees relative to slab 44, the polarization of the intermediate generated linearly polarized signal, as detected by LNB dipole 38 or 40, stays fixed and complies with the incoming left hand circular polarized signal or right hand circular polarized signal.

The embodiments described above have an acceptable XPD of at least 30 dB in the Ku transmission band (13.75 GHz to 14.5 GHz) or at least 20 dB in the Ku reception band (10.9 GHz to 12.75 GHz) but not in both bands simultaneously. Therefore, LNBF 30 is suitable for a reception-only system, such as a Television Receive Only (TVRO) system. To obtain acceptable XPD performance throughout the whole Ku band (10.9 GHz to 14.5 GHz), yielding a XPD of 40 dB in transmission and 20 dB in reception, the dual quad ridge design of Vezmar, U.S. Pat. No. 6,097,264 is used. U.S. Pat. No. 6,097,264 is incorporated by reference for all purposes as if fully set forth herein.

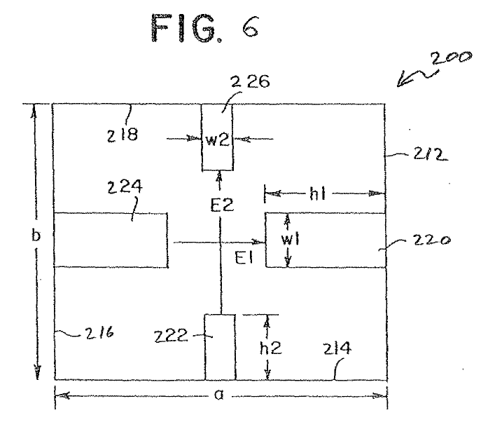

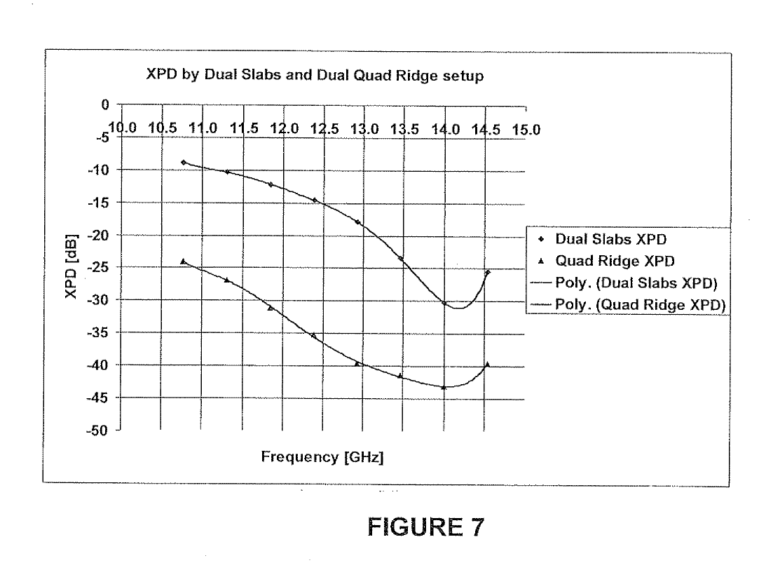

FIGS. 5 and 6, that are adapted from U.S. Pat. No. 6,097,264, show a broad band quad ridge polarizing waveguide 200. The waveguide has width a, height b, and length L. Preferably the height and width of the waveguide are equal. However this is not essential and the waveguide may have a rectangular or even a curved cross section. Waveguide 200 has four wall regions, such as walls 212, 214, 216, and 218, each having a respective axial ridge 220, 222, 224, 226. The addition of a second pair of opposing ridges results in a lower cutoff frequency of the waveguide and increased frequency at which higher order modes can occur, therefore providing a device which operates over a relatively broad range of frequencies. The second pair of ridges have similar phase vs. frequency characteristics as the first pair. This allows for non-divergent phase characteristics over a relatively large bandwidth. Preferably, opposing ridges 220, 224 and 222, 226 are in alignment with each other. More preferably, each of the ridges is positioned equally distant from the two adjacent wall regions and run down the center of the wall on which it is located, as shown in the cross-section of FIG. 6. Most preferably, opposing ridges 20, 24 and 22, 26 are symmetric to each other and ridge pair 20, 24 has a different geometry than ridge pair 22, 26.

The first pair of opposing ridges 220, 224 each have a height h1 inward from the respective walls 212, 216, a width w1, and a length L1. The height, width, and length of these ridges determines the phase shift of signal component E1. Similarly, the second pair of opposing ridges 222, 226 each have a height h2 inward from respective walls 214, 218, a width w2, and a length L2. The dimensions of ridges 222, 226 determine the phase shift of the other signal component, E2. The design of single and dual axial ridges is well known to those of skill in the art. See, e.g., W. Hoefer and M. Burton, Closed-Form Expressions for the Parameters of Finned and Ridged Waveguides, IEEE Transactions on Microwave Theory and Techniques, Vol. MTT-30, No. 12, pp. 2190-2194, December 1982. Similar techniques may be utilized to select the proper dimensions for the additional ridges provided in the quad ridge configuration of FIGS. 5 and 6.

Advantageously, the variability in the height, width, and length of the four ridges allows sufficient freedom of design to achieve the two different phase velocities as required for broad band performance. The difference in phase between signal components E1 and E2 is designed to provide a circularly polarized output signal within the frequency range of interest. A wide bandwidth can be achieved if the phase characteristics of the orthogonal signal components E1 and E2 entering the waveguide 200 are approximately 90 degrees apart and have the same curvature over a wide frequency range. An exact match in curvature is achieved when both pairs of ridges are identical. However, this situation would not introduce the necessary phase difference between the components.

The dimensions of the ridges may be chosen to provide similar phase characteristics with close to a 90 degree phase difference over a wide frequency range. One configuration for achieving this result is for the first pair of ridges 220, 224 to have a relatively large width w1 and height h1, but a small length L1, while the second pair of ridges 222, 226 have a comparatively narrow width w2, small height h2, but a long length L2. In other words, w1 is greater than w2, h1 is greater than h2, and L1 is less than L2. Generally, the ridge width is not as critical a dimension as the length and height while in general, a relatively large height corresponds to a relatively small length. So in an alternate configuration, w1 is equal to or even less than w2 while h1 is greater than h2, and L1 is less than L2.

Preferably, the ends of the ridges are also stepped, as illustrated in FIG. 5. Stepping the ridges reduces the mismatch in impedance which results when there is an abrupt transition from a smooth to ridged waveguide wall by providing a gradual impedance transformation between the ridged portion of the waveguide and the input and output waveguide portions, which may be rectangular, square, or even curved. The design of stepped ridges is well known to those skilled in the art. See, e.g., S. Hopfer, The Design of Ridged Waveguides, IRE Transactions on Microwave Theory and Techniques, Vol. MTT-3 pp. 20-29, October 1955.

A quad ridge polarizer may be manufactured as an integral die cast device. Advantageously, a quad ridge polarizer is inexpensively and accurately manufactured as an integrally molded component using die cast fabrication techniques and without the need to integrate dielectric materials with metallic materials. Preferably, the waveguide is made of aluminum or zinc, depending on its size. Other conventional materials such as copper also may be used.

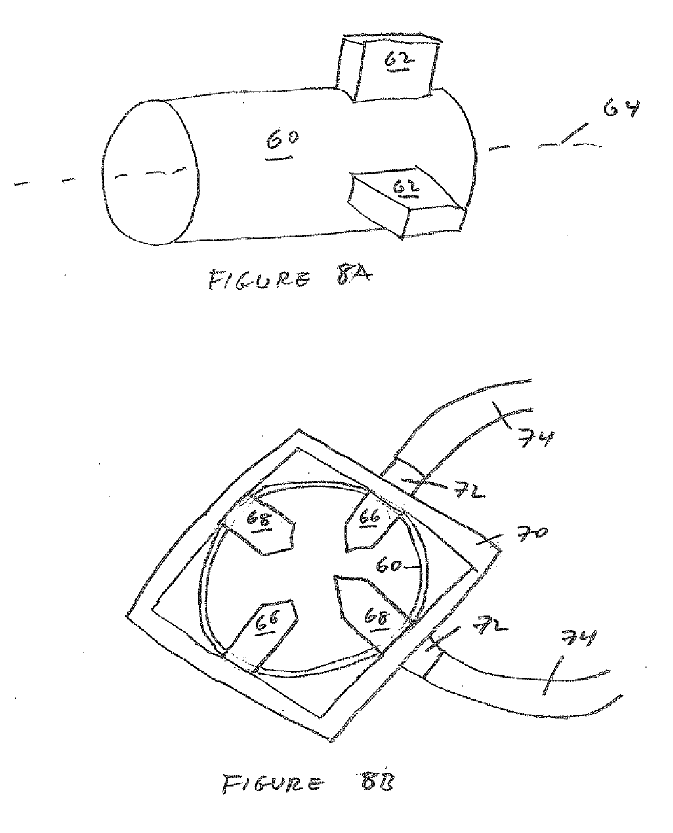

FIG. 7 is a plot of XPD in dB vs. frequency in GHz for the dual slab polarizer of FIG. 3 vs. for the quad ridge polarizer of FIGS. 5 and 6.

The superior XPD of a quad ridge polarizer allows a LNBF that uses such polarizers as polarizers 32 and 34 to be used for simultaneous reception and transmission. LNBF 31 of FIG. 2B is such a LNBF. OMT 36 couples a LNB (not shown) for reception and a Block Up-Converter (BUC) (not shown) for transmission to waveguide 50. The LNB and the BUC are coupled to OMT 36 at branch waveguides similar to distal branch waveguides 82 of FIG. 9 below. OMT 36 provides for simultaneous reception in one linear polarization and transmission in the other polarization by providing 35 dB decoupling (isolation) between transmission and reception. In addition, the LNB includes a transmission reject filter for an additional 35 dB isolation at minimum for undisturbed reception by the LNB in the receive band during transmission via the transmit band in the same LNBF 31.

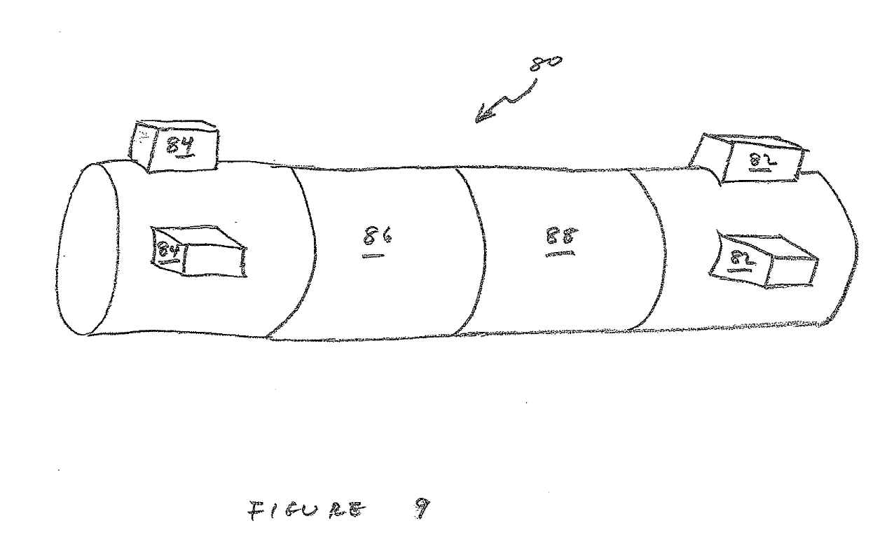

In the embodiments of FIG. 2, polarizers 32 and 34 are upstream from the LNB dipole(s) in reception and downstream from the transmission dipole of the BUC in transmission. FIGS. 8 and 9 illustrate embodiments in which the mechanism for untangling the mixed linear polarizations is downstream from the orthogonal dipoles of a fixed (not rotating to align the dipoles with the satellite transponders) antenna in reception and upstream from the antenna dipoles in transmission.

FIG. 8A is a perspective view of the distal portion of a main waveguide 60 that has a circular cross-section and a longitudinal axis 64. At the distal end of main waveguide 60 are two branch waveguides 62. FIG. 8B is an end-on view of the proximal end of main waveguide 60, showing that at the proximal end of main waveguide 60 there is a frame 70 that is rotatable about axis 64. Mounted in frame 70 are two electrically-conducting dipole pairs 66 and 68. Each dipole pair 66 or 68 is coupled, via a respective coax adapter 72 and a respective coaxial cable 74, to a respective one of the antenna dipoles.

In the frame of reference of the communication satellite, the received or transmitted signals are:

Horizontal signal: Hₓ(t)=H₀(t)

Vertical signal: V_{y}(t)=V₀(t)

Because the antenna is, in general, tilted with respect to the frame of reference of the satellite at an angle θ, the signals to/from the LNB are

Hₓ₁(t)=Hₓ(t)cos(θ)+V_{y}(t)sin(θ)

V_{y1}(t)=−Hₓ(t)sin(θ)+V_{y}(t)cos(θ)

Following back-rotation by dipole pairs 66 and 68, the signals from/to branch waveguides 62 are:

$$\begin{matrix}{H}_{x 2} ( t ) = {H}_{x 1} ( t ) cos ( θ ) - {V}_{y 1} ( t ) sin ( θ ) \\ = [ {H}_{x} ( t ) cos ( θ ) + {V}_{y} ( t ) sin ( θ ) ] cos ( θ ) - \\ [ - {H}_{x} ( t ) sin ( θ ) + {V}_{y} ( t ) cos ( θ ) ] sin ( θ ) \\ = {H}_{x} ( t ) [ {cos}^{2} ( θ ) + {sin}^{2} ( θ ) ] + {V}_{y} ( t ) [ sin ( θ ) cos ( θ ) - cos ( θ ) sin ( θ ) ] \\ = {H}_{x} ( t ) \\ {V}_{y 2} ( t ) = {H}_{x 1} ( t ) sin ( θ ) + {V}_{y 1} ( t ) cos ( θ ) \\ = [ {H}_{x} ( t ) cos ( θ ) + {V}_{y} ( t ) sin ( θ ) ] sin ( θ ) + \\ [ - {H}_{x} ( t ) sin ( θ ) + {V}_{y} ( t ) cos ( θ ) ] cos ( θ ) \\ = {H}_{x} ( t ) [ cos ( θ ) sin ( θ ) - sin ( θ ) cos ( θ ) ] + {V}_{y} ( t ) [ {sin}^{2} ( θ ) + {cos}^{2} ( θ ) ] \\ = {V}_{y} ( t )\end{matrix}$$

Frame 70 is rotated by antenna controller 120, similarly to how polarizer 32 is rotated by antenna controller 120, to maintain frame 70 at the angle θ that ensures that each branch waveguide 62 is dedicated to the correct signal.

The embodiment of FIGS. 8A and 8B suffers from the disadvantage that coaxial cables 74 can easily become entangled with each other. The embodiment illustrated in FIG. 9 overcomes this disadvantage. The embodiment illustrated in FIG. 9 includes a main waveguide 80 of circular cross-section. At the distal end of main waveguide 80 are two distal branch waveguides 82. One branch waveguide is coupled to an LNB (not shown) for reception; the other branch waveguide is coupled to a BUC (not shown) for transmission. At the proximal end of main waveguide 80 are two proximal branch waveguides 84. Each proximal branch waveguide is coupled to a respective antenna dipole by a coaxial cable (not shown). Between distal branch waveguides 82 and proximal branch waveguides 84 are two quarter-wave quad ridge polarizers: a rotating polarizer 86 and a fixed polarizer 88. Fixed polarizer 88 is fixed at a 45-degree angle to distal branch waveguides 82, just as slab 44 of fixed polarizer 34 is fixed at a 45-degree angle to LNB dipoles 38 and 40.

The signals from/to distal branch waveguides 82 to/from proximal branch waveguides 84 are:

H(t)=H[x cos(θ)+y sin(θ)] sin(ωt)

V(t)=V[−x sin(θ)+y cos(θ)] sin(ωt)

where θ is the misalignment angle between the LNB polarization direction and the satellite's frame of reference. Antenna controller 120 dynamically adjusts the alignment angle of rotating polarizer 86 to be θ+45 degrees resulting in two circular wave components having the signals H(t) and V(t) respectively in the following form:

H(t)=H[x cos(ωt)+y sin(ωt)]

V(t)=V[−x sin(ωt)+y cos(ωt)]

which are clockwise and counterclockwise circularly polarized waves. Polarizer 88, that is fixed at 45 degrees relative to distal branch waveguides 82, transforms the circular polarized waves back to linear polarized waves that match the receive and transmit ports. Which one of distal branch waveguides 82 is to be coupled to the LNB and which is to be coupled to the BUC is determined by which of the two possible 45-degree orientations, relative to distal branch waveguides 82, that polarizer 88 is fixed in.

It will be appreciated that the satellite communication technology described herein is an instantiation of an innovative method for rotating the plane of polarization of a linearly polarized transverse wave such as a linearly polarized electromagnetic wave (or, for that matter, any other linearly polarized transverse wave, e.g. a linearly polarized shear wave. The linearly polarized transverse wave is transformed into a circularly polarized wave. Then, the circularly polarized wave is transformed into a linearly polarized transverse wave whose plane of polarization is rotated as desired. Heretofore, polarizer slabs such as slabs 42 and 44 of FIGS. 2C and 2D, and quad ridge polarizers such as those taught by Vezmar, have been used to convert circularly polarized signals to and from linearly polarized signals, but have not been used to rotate the polarization planes of linearly polarized signals.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A ground station antenna comprising:
(a) a low noise block having at least one dipole;
(b) a feed horn;
(c) a waveguide, between said low-noise block and said feed horn, operative to transform a polarization of an electromagnetic wave propagating between said low-noise block and a communications satellite; and
(d) a mechanism for rotating at least a portion of said waveguide, relative to said low-noise block, so as to match said polarization to a respective dipole of said low-noise block and also to a satellite antenna on said communication satellite.

2. The ground station antenna of claim 1, wherein said waveguide includes two polarizers, and wherein said mechanism rotates a first one of said polarizers while a second one of said polarizers remains fixed relative to said at least one dipole of said low-noise block.

3. The ground station antenna of claim 2, wherein each said polarizer includes a single respective dielectric slab.

4. The antenna of claim 3, wherein said dielectric slabs are quarter-wavelength dielectric slabs.

5. The ground station antenna of claim 3, wherein said second dielectric slab is fixed at a 45-degree angle relative to said at least one dipole.

6. The ground station antenna of claim 2, wherein said polarizers are quad ridge polarizer.

7. The ground station antenna of claim 6, wherein said quad ridge polarizers are quarter-wavelength quad ridge polarizers.

8. The ground station antenna of claim 6, wherein said second quad ridge polarizer is fixed at a 45-degree angle relative to said at least one dipole.

9. The ground station antenna of claim 1, wherein said low noise block includes two orthogonal dipoles.

10. A ground station antenna comprising:
(a) a main waveguide;
(b) two mutually orthogonal distal branch waveguides at a distal end of said main waveguide;
(c) a coupling mechanism for coupling two orthogonal antenna dipoles to a proximal end of said main waveguide; and
(d) a transformation mechanism operative to transform a polarization of an electromagnetic wave propagating between said distal branch waveguides and a communications satellite via said antenna dipoles so as to match said polarization to one of said distal branch waveguides and also to a satellite antenna on said communication satellite.

11. The ground station antenna of claim 10, wherein said transformation mechanism includes two pairs of dipoles mounted rotatably about a longitudinal axis of said main waveguide at said proximal end of said main waveguide, with both said pairs of dipoles being oriented perpendicular to each other and to said longitudinal axis.

12. The ground station antenna of claim 11, wherein said coupling mechanism couples each said antenna dipole to one dipole of a respective said pair of dipoles.

13. The ground station antenna of claim 10, wherein said coupling mechanism includes two mutually orthogonal proximal branch waveguides at said proximal end of said main waveguide, with each said proximal branch waveguide being coupled to a respective one of said antenna dipoles, and wherein said transformation mechanism includes two polarizers integral to said main waveguide, with a first said polarizer being rotatable, relative to said branch waveguides, about a longitudinal axis of said main waveguide while a second said polarizer remains fixed relative to said branch waveguides.

14. The ground station antenna of claim 13, wherein said second polarizer is fixed at a 45-degree angle relative to said distal branch waveguides.

15. The ground station antenna of claim 13, wherein said polarizers are quad ridge polarizers.

16. The ground station antenna of claim 15, wherein said polarizers are quarter-wavelength quad ridge polarizers.

17. A method of rotating an input direction of polarization of a linearly polarized transverse wave to an output direction, comprising the steps of:
(a) transforming the transverse wave into a circularly polarized transverse wave; and
(b) transforming said circularly polarized transverse wave into a linearly polarized transverse wave whose direction of polarization is the output direction.
